(19) United States
(12) Patent Application Publication
(10) Pub. No.: US 2003/0049398 A1
(43) Pub. Date: Mar. 13, 2003

(54) Polymer nanocomposite and process for making the same

(76) Inventor: Thomas S. Ellis, Romeo, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/269,560

(22) Filed: Oct. 11, 2002

Related U.S. Application Data
(63) Continuation-in-part of application No. 09/650,895, filed on Aug. 30, 2000.
(60) Provisional application No. 60/172,559, filed on Dec. 18, 1999.

(51) Int. Cl. B32B 1/02

(52) U.S. Cl. 428/36.6

(57) ABSTRACT

Disclosed herein is a method for producing a nanocomposite, comprising exfoliating a nanofiller in a first polymer to form a precursor, combining the precursor with a second polymer to exfoliate the nanofiller in the second polymer; and wherein the second polymer is miscible with the first polymer and less than about 10 wt % of the nanofiller exfoliates when mixed directly with the second polymer, and greater than or equal to about 10 wt % of the nanofiller exfoliates in the nanocomposite when the precursor and second polymer are combined. Further disclosed herein is a nanocomposite comprising a first polymer having a nanofiller exfoliated in the first polymer, a second polymer, and wherein the second polymer is miscible with the first polymer and less than about 10 wt % of the nanofiller exfoliates when mixed directly with the second polymer, and greater than or equal to about 10 wt % the nanofiller exfoliates in the nanocomposite when the precursor and second polymer are combined.

### CROSS REFERENCE TO RELATED APPLICATIONS

This application is a continuation-in-part of U.S. application Ser. No. 09/650,895 filed on Aug. 30, 2000, which claims priority to U.S. Provisional Application Serial No. 60/172,559 filed on Dec. 18, 1999, which are fully incorporated herein by reference.

### BACKGROUND

The present disclosure relates to a polymer nanocomposite and process for making the same.

Nanocomposites are compositions in which at least one of its constituents has one or more dimensions, such as length, width or thickness, in the nanometer (1×10⁻⁹meters) size range. The term “nanofiller” (also referred to as platy fillers) refers to these nanoscale constituents. A nanofiller generally comprises a filler material having a major diameter less than or equal to about 100 nanometers. Nanofillers are generally present in an amount of about 1 wt % to about 50 wt %, weight percent based on the total weight of a nanocomposite. Additionally, nanofillers generally have a surface area to thickness aspect ratio of about 50 to about 1,000. Common sources of nanofillers for polymers are found as naturally occurring smectite clays or layered silicates such as montmorillonite. Man-made nanofillers, such as synthetic mica are also available.

The term “polymer nanocomposite”, as used herein, denotes the state of matter wherein polymer molecules exist among at least partially exfoliated clay layers. Polymer-clay nanocomposites, for example, can be characterized as being one of several general types: intercalated nanocomposite, exfoliated nanocomposite, and combinations thereof. The term “intercalated nanocomposite,” as used herein, describes a nanocomposite that has a regular insertion of the polymer in between the aggregated clay layers. The term “exfoliated nanocomposite,” as used herein, describes a nanocomposite having a nanofiller dispersed predominantly in an individual state throughout the polymer, i.e., microscopic and X-ray diffraction methods are unable to detect a semblance of regular structure or order of the nanofiller, signifying a random arrangement of the nanofiller. An exfoliated nanocomposite maximizes the polymer-clay interactions, thereby making the entire surface of the clay layers available for the polymer and is therefore a more preferred form of nanocomposite.

In addition to improved mechanical properties, such as modulus and heat deflection temperature, nanocomposites have been shown to possess improved flame resistance and enhanced barrier performance, i.e., reduced permeability to a diffusing species when compared to the unmodified polymer. The term “barrier” refers to a material or a material structure such as a film, layer, membrane or surface coating that obstructs the penetration or permeation of fluids through or beyond the material or material structure acting as the barrier.

An ethylene-vinyl alcohol copolymer (EVOH) has been used as a barrier layer in a multilayer fuel tank, as EVOH has been shown to reduce hydrocarbon emissions compared to other polymers employed as barrier layers for fuel components. However, the effectiveness of EVOH as a barrier layer generally is diminished with fuels that include methanol. Methanol has been found to plasticize the EVOH barrier layer making it more permeable when compared to the un-plasticized EVOH. Moreover, fabricating EVOH nanocomposites has been unsuccessful, because only intercalated nanocomposites have been prepared and exfoliation of the nanofiller in the EVOH cannot be achieved.

### BRIEF SUMMARY

Disclosed herein is a method for producing a nanocomposite, comprising exfoliating a nanofiller in a first polymer to form a precursor, and combining the precursor with a second polymer to exfoliate the nanofiller in the second polymer, wherein the second polymer is miscible with the first polymer and less than 10 wt % of the nanofiller exfoliates when mixed directly with the second polymer, and greater than or equal to about 15 wt % of the nanofiller exfoliates in the nanocomposite when the precursor and second polymer are combined.

Further disclosed herein is a nanocomposite comprising a first polymer having a nanofiller exfoliated in the first polymer, a second polymer, and wherein the second polymer is miscible with the first polymer and less than 10 wt % of the nanofiller exfoliates when mixed directly with the second polymer, and greater than or equal to about 15 wt % the nanofiller exfoliates in the nanocomposite when the precursor and second polymer are combined. The above-described and other features will be appreciated and understood by those skilled in the art from the following detailed description, and appended claims.

A fuel tank for a vehicle comprising a tank shell having a wall formed from a plurality of layers, wherein the plurality of layers comprises at least an inner layer and an outer layer; and a barrier layer disposed between the inner layer and the outer layer, wherein the barrier layer comprises a nanocomposite comprising a polycaproamide having a nanofiller exfoliated in the polycaproamide and an ethylene-vinyl alcohol copolymer, wherein the ethylene-vinyl alcohol copolymer is miscible with the polycaproamide and is present in an amount of about 10 wt % to about 60 wt % based on the total weight of the nanocomposite, wherein less than 10 wt % of the nanofiller exfoliates when mixed directly with the second polymer, and wherein greater than or equal to about 15 wt % the nanofiller exfoliates in the nanocomposite when the polycaproamide and second polymer are combined.

The above described and other features are exemplified by the following figures and detailed description.

### BRIEF DESCRIPTION OF THE DRAWINGS

FIG. 1 is a perspective view of a fuel tank; and

FIG. 2 is a sectional view taken along line 2-2 of FIG. 1.

### DETAILED DESCRIPTION

The present disclosure relates to a nanocomposite and method for making the same. The nanocomposite comprises a precursor and an ethylene-vinyl alcohol (EVOH) copolymer, wherein the precursor comprises a first polymer and an exfoliated nanofiller. Although the following description focuses on a nanocomposite comprising EVOH and a polymer miscible with EVOH, it is understood that the disclosure is broader than such a composition. It has been discovered that, although it can be very difficult to produce nanocomposite structures that exhibit either synergistic properties or at least the combined properties of the polymer and the filler due to agglomeration of the nanofiller within the polymer, these nanocomposites can be formed by dispersing the nanofiller in a particular polymer prior to dispersion in the desired polymer. The particular polymer employed to carry the nanofiller is a polymer that is both miscible with the desired polymer and is capable of forming an exfoliated nanocomposite, i.e., the nanofiller is dispersed in the particular polymer such that an appreciable reduction of permeability to a diffusing fluid is observed and analytical techniques such as microscopy and X-ray diffraction indicate no order or layered aggregates.

As stated above, the first polymer comprises a material capable of functioning as a nanocomposite, i.e., acting as a carrier for the nanofiller, wherein the nanofiller is exfoliated, and is miscible with the desired polymer, e.g., EVOH. As used herein, the term “miscible” refers to a state where a blend of two or more components forms a homogeneous mixture on a molecular scale. Some possible first polymers include polyamides, polystyrenes, polyetherimides, acrylates (e.g., methacrylate oligomers, a polymethyl methacrylates, and the like), polypropylenes, polyethylene oxides, epoxies, polyimides, polyesters, polycarbonates, acrylonitrile-butadiene-styrene copolymers, and combinations comprising at least one of the foregoing first polymers, and the like.

For use with EVOH as a barrier, e.g., in a fuel tank or other fuel-carrying device such as a tube or fuel line, a polyamide nanocomposite is preferred, with the polyamide derived from polycaproamide more preferred. The term “barrier” refers to a material or a material structure such as a film, layer, membrane or surface coating, that obstructs the penetration or permeation of fluids through or beyond the material or material structure acting as the barrier.

The nanofiller carried in the first polymer can comprise any filler that can be exfoliated in the first polymer and subsequently exfoliated in the nanocomposite comprising the first polymer and the desired polymer (e.g., the EVOH). The nanofiller is further selected based upon the properties that it can impart to the final product, e.g., to the barrier. Possible nanofillers comprise a nanoscale size material, i.e., any filler having a major diameter of less than or equal to about 100 nanometers (nm).

Some possible fillers include clays (e.g., natural clays, synthetic clays, and modified phyllosilicates), carbon (e.g., nanotubes, nanoparticles, and the like), and the like, as well as combinations comprising at least one of the foregoing fillers. Some possible natural clays include smectite clays such as montmorillonite, saponite, hectorite, mica, vermiculite, bentonite, nontronite, beidellite, volkonskoite, magadite, kenyaite, and the like. Some possible synthetic clays include synthetic mica, synthetic saponite, synthetic hectorite, and the like. Some possible modified clays include fluoronated montmorillonite, fluoronated mica, and the like.

The desired polymer is combined with the precursor comprising the nanofiller carried in the first polymer to form the nanocomposite. The desired polymer can be any polymer miscible with the first polymer and in which the nanofiller cannot be directly exfoliated, i.e., the nanofiller cannot be combined with the desired polymer to form a nanocomposite because less than about 10 wt % of the nanofiller exfoliates directly in the desired polymer (based on the total weight of the nanofiller without first dispersing the nanofiller in the first polymer.

For a fuel component application, for example, the desired polymer comprises EVOH. This EVOH can comprise less than or equal to about 45 mole percent (mol %) ethylene. Preferably, the EVOH comprises greater than or equal to about 20 mol % ethylene, with greater than or equal to about 25 mol % more preferred. Also preferred is less than or equal to about 40 mol % ethylene, with less than or equal to about 35 mol % more preferred.

With respect to the nanocomposite, the amounts of the various components can vary depending upon the type of first polymer, type of second polymer (i.e., desired polymer), and type of nanofiller, as well as the desired resultant properties. For a fuel component barrier, for example, the nanocomposite can comprise about 10 weight percent (wt %) to about 60 wt % EVOH. It may also comprise about 5 wt % to about 70 wt % first polymer, and about 0.5 wt % to about 25 wt % nanofiller. About 25 wt % to about 50 wt % EVOH is preferred for a fuel component barrier.

The nanocomposite can be produced via various techniques including mixing, kneading, melt blending, and other methods. Nanofiller(s) are exfoliated in a first polymer to form a precursor and the precursor is combined (preferably melt blended) with the desired polymer (e.g., EVOH). The resulting nanocomposite comprises nanofiller exfoliated in the melt blended (or reaction) product of the desired polymer and the first polymer. For example, nanofiller and polyamide can be introduced to the neck of an extruder. The extruder may have either one or two screws but provides sufficient mixing and mastication to homogenize the mixture. EVOH can then be introduced to the extruder downstream of the polyamide and the nanofiller. The extruder is preferably operated at a sufficient temperature to melt both the polyamide and the EVOH, thereby sufficiently blending the precursor and the EVOH to exfoliate the nanofiller in the EVOH. Generally, for the polyamide/EVOH system, the extruder can be operated at temperatures of about 180° C. to about 240° C., with a length/diameter (L/D) ratio of the extruder of about 20 or more.

Once formed, the nanocomposite can be used as desired. For example, the nanocomposite can be employed as a barrier layer in a fuel tank. The nanocomposite can be incorporated as a barrier layer in the fuel tank by any technique capable of disposing the nanocomposite as desired, e.g., thermoforming, molding (e.g., blow molding, injection molding, vacuum molding, and the like), extrusion, lamination, bonding, and others, as well as combinations comprising at least one of these techniques. Preferably, the fuel tank is a multilayer structure produced by co-extrusion in which the barrier layer is sandwiched between polyethylene layers.

For example, a barrier layer for a fuel tank can be extruded as a multilayer sheet or film with other polymers such as polyethylene, having a thickness of up to several millimeters (mm). Generally, the nanocomposite is extruded as a sheet having a thickness of about 0.04 millimeters to about 1 millimeter, with a thickness of about 0.4 millimeters to about 0.8 millimeters preferred. The fuel tank may then be disposed in fluid communication with a fuel-consuming device such as an engine, machinery, and the like. For example, the fuel tank can be mounted on a vehicle in fluid communication with an engine or, in a facility/factory in fluid communication with a generator and/or machinery. It may also be used as a portable or stationary storage container. In addition to the fuel tank, other barrier layer applications include, but are not limited to, fuel lines, hoses, and similar products where prevention of seepage or migration of a fluid through the barrier is desired.

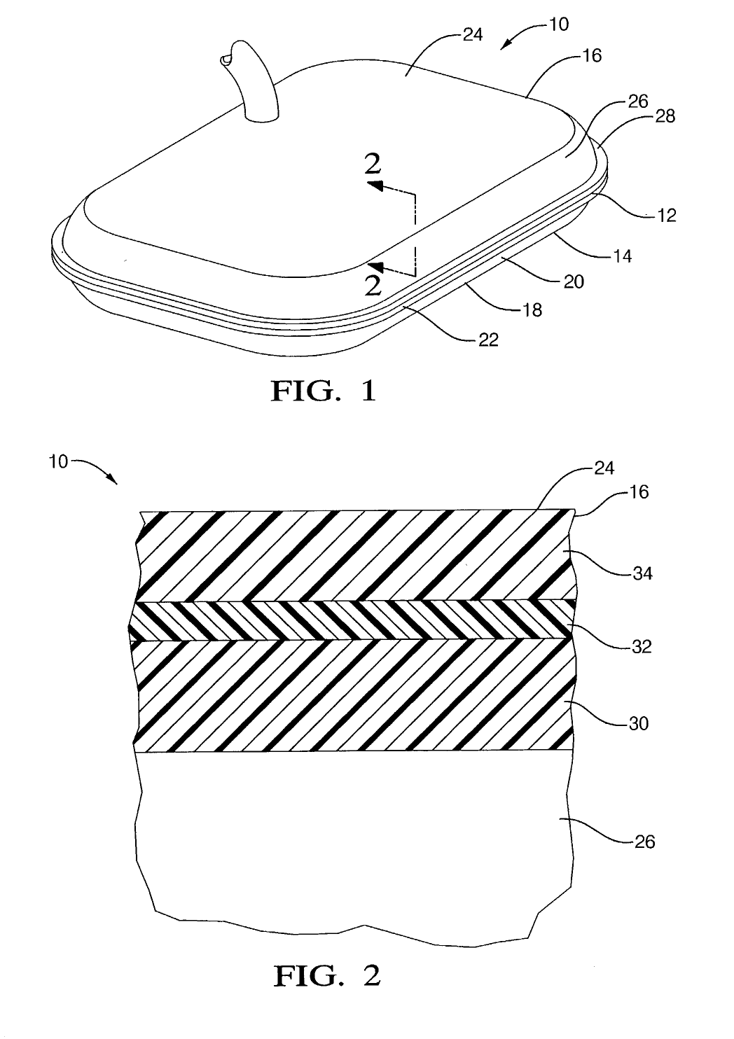

Referring now to FIGS. 1 and 2, there is shown an exemplary fuel tank 10 including a barrier layer. The fuel tank 10 includes a tank shell 12 that is of a generally rectangular type. The tank shell 12 includes a first or lower half shell 14 and a second or upper half shell 16. The lower half shell 14 has a base wall 18 and a side wall 20 around a periphery of the base wall 18 and extending generally perpendicular thereto. The side wall 20 has a flange 22 extending outwardly and generally perpendicular thereto. The upper half shell 16 has a base wall 24 and a side wall 26 around a periphery of the base wall 24 and extending generally perpendicular thereto. The side wall 26 has a flange 28 extending outwardly and generally perpendicular thereto. The flanges 22 and 28 of the lower half shell 14 and upper half shell 16, respectively, are joined together to form a seam by suitable means such as by thermoforming, compression molding or friction welding. The lower half shell 14 and upper half shell 16 are made of a rigid material such as a thermoformable plastic.

Referring to FIGS. 1 and 2, the fuel tank 10 has the base walls 18, 24, side walls 20, 26, and flanges 22, 28 formed from a plurality of layers 30, 32, 34. The first or inner layer 30 is made from a thermoformable polymer such as a high density polyethylene (HDPE) or similar polyolefin. The inner layer 30 has a predetermined thickness of approximately two millimeters (2.00 mm).

The second barrier layer 32 is made from the nanocomposite polymer as previously described and is interposed between the inner layer 30 and an outer layer 34. The second barrier layer 32 preferably has a predetermined thickness of approximately 0.1 mm to approximately 1.0 mm or two percent to approximately six percent of a total thickness of the layers.

The third or outer layer 34 is made from a thermoformable polymer such as a high density polyethylene (HDPE) or similar polyolefin. The outer layer 34 preferably has a predetermined thickness of approximately two millimeters (2.00 mm).

In manufacturing the fuel tank 10, several processes may be used. Preferably, the fuel tank 10 is formed by a thermoforming process, wherein the second barrier layer 32 can be thermoformed by heat and pressure along with the inner layer 30 and the outer layer 34. The presence of the nanofiller material presents an efficient obstacle to the transport, i.e., diffusion, of penetrant molecules, such as those normally found in fuels. It should be appreciated that the incorporation of the polymer nanocomposite as the barrier layer for the second barrier layer 32 in the fuel tank 10 provides a significant improvement over conventional barrier materials in preventing permeation of fuel to the atmosphere. It should also be appreciated that nanocomposite polymer of the fuel permeation barrier layer 32 can be included in the assembly of the permeation barrier fuel tank 12 by other thermoforming techniques, for example, extrusion, lamination, and the like processes.

### EXAMPLE

Methanol transport was studied in a nanocomposite comprising a PA-6 polymer (i.e., polycaproamide) having a nanofiller exfoliated in the polymer, and an ethylene-vinyl alcohol copolymer (EVOH). Moreover, methanol transport was studied at varying EVOH concentrations in the nanocomposite. In this example, the diffusion coefficient (D) for a nanocomposite was approximated by equation 1.

Mₜ/M_{∞}=4(Dₜ/πl²)^{½} (1)

By measuring the increase of mass (Mₜ) as a function of time “t” and plotting this as Mₜ/M_{∞}versus (t/l²)^{½} a straight line of slope 4(D/π)^{½} was obtained, from which D may be determined, wherein “l” refers to sample thickness. The permeability coefficient for the nanocomposite was then obtained.

However, before a nanocomposite could be studied, it had to first be produced. The steps employed were as follows.

A nanofiller was exfoliated in a first polymer, i.e., nylon, to form a precursor (one such material is commercially available as M1030, manufactured by Unitika Ltd., Japan). The amount of nanofiller used in the precursor was about 4 wt % synthetic phillosilicate, based upon the total weight percent of the precursor.

Next, the precursor was combined with a second polymer, i.e., an ethylene-vinyl alcohol copolymer (EVOH) containing about 25 mole percent to about 35 mole percent ethylene. More particularly, samples were prepared with EVOH commercially available as EVAL J102B, and EVAL F101A, manufactured by Evalca of America, Lisle, Ill. The precursor and the EVOH were melted and blended using an extruder, e.g., a DSM Research miniextruder and injection molder.

Thermal analysis and transmission electron microscopy were used after combining the precursor and the second polymer to determine if they were in fact were miscible, i.e., homogeneous mixing had occurred. Further, X-ray analysis was used to determine if the nanofiller was exfoliated in the blend. The absence of a peak in the X-ray diffraction curve confirmed complete exfoliation.

Samples 1-3 used EVAL J102B as the second polymer, and Samples 4-6 used EVAL F101A as the second polymer. The samples were prepared at three different weight percents for the second polymer, i.e., at 25 wt %, 50 wt %, and 75 wt %, weight percents were based on the total weight of the nanocomposite. Control was prepared using EVOH obtained commercially as EVAL J102B. Control 2 was prepared using EVOH obtained commercially as EVAL F101A. Control 3 was prepared using nylon (PA-6) nanocomposite obtained commercially as M1030 (i.e., comprised 4 wt % synthetic phillosilcate). Methanol transport data were then collected. The results are shown in Table 1.

TABLE 1

| | | | Diffusion | Sorption | Permeability |
|---|---|---|---|---|---|
| | | | Coefficient × | Coefficient | Coefficient × |
| Sample | Composition | Blend Ratio | 10⁻¹³ m²s⁻¹ | g/g | 10⁻¹⁴ m²s⁻¹ |
| Sample 1 | EVOH/M-1030 | 25:75 | 1.59 | 0.123 | 1.96 |
| Sample 2 | EVOH/M-1030 | 50:50 | 3.32 | 0.158 | 5.25 |
| Sample 3 | EVOH/M-1030 | 75:25 | 7.09 | 0.179 | 12.67 |
| Sample 4 | EVOH/M-1030 | 25:75 | 1.59 | 0.125 | 1.99 |
| Sample 5 | EVOH/M-1030 | 50:50 | 1.59 | 0.146 | 2.33 |
| Sample 6 | EVOH/M-1030 | 75:25 | 5.02 | 0.161 | 8.10 |
| Control 1 | EVOH | | 2.83 | 0.178 | 5.03 |
| Control 2 | EVOH | | 2.00 | 0.159 | 3.30 |
| Control 3 | M-1030 | | 1.59 | 0.133 | 2.11 |

In the following discussion of the results, the units have been omitted. The units are shown in the heading of Table 1.

As previously mentioned, the first polymer had about 4 wt % synthetic phillosilicate nanofiller exfoliated in it, weight percent was based on the total weight of the first polymer. However, the resulting nanocomposites had “diluted” amounts of nanofiller based on the weight percent of nanofiller in the nanocomposites, e.g., a 50:50 blend had about 2 wt % nanofiller, weight percents were based on the total weight the nanocomposite. All things being equal, a nanocomposite having 4 wt % nanofiller based on the total weight of the nanocomposite, would have even greater barrier properties to methanol when compared to the nanocomposite samples tested.

The nanocomposite samples containing 25 wt % of the respective EVOH component (Sample 1 and Sample 4) showed the optimal results in the study, weight percent was based on the total weight of the nanocomposite. The resulting permeability coefficients for the Sample 1 and Sample 4 were 1.96 and 1.99 respectively. Control 1, Control 2, and Control 3 had permeability coefficients of 5.03, 3.30, and 2.11 respectively. Both Sample 1 and Sample 2 showed improved barrier properties to methanol, i.e., the permeability coefficients were less than the control values. Moreover, the nanocomposite did not appear to be influenced by the EVOH component used. Finally, surprisingly, eventhough Control 3 comprised 4 wt % nanofillers and that EVOH alone (Controls 1 and 2) had higher permeability coefficients than Control 3, combining EVOH with the nylon-6/nanofillers produced a lower permeability coefficient. Consequently, combining about 5 wt % to about 40 wt % EVOH with polyamide and a nanofiller improves the permeability coefficient of the resulting material, i.e., attains a permeability coefficient of less than or equal to 4.5×10⁻¹⁴ m²/s with a permeability coefficient of less than or equal to 3×10⁻¹⁴ m²/s readily attainable, and a permeability coefficient of less than or equal to about 2×10⁻¹⁴ m²/s preferred.

As the EVOH concentration increased to 75 wt % in the nanocomposite, however, the resulting permeability coefficients appeared to be influenced by the EVOH concentration in the nanocomposite. For example, Sample 2 had a permeability coefficient of 5.25, and Sample 5 had a permeability coefficient of 2.33; weight percents were based on the total weight of the nanocomposite. Without being bound to any particular theory, the general inferior performance of Samples 1-3, compared to Samples 4-6 may be traceable in part to the lower degree of crystallization of the EVOH used in Samples 1-3.

Further, Sample 3 and Sample 6 both appeared to be even more permeable to methanol than the control groups. The permeability coefficients of Control 1, Control 2, and Control 3 were 5.03, 3.30, and 2.11 respectively, whereas Sample 3 and Sample 6 had permeability coefficients of 12.67 and 8.10 respectively. Without being bound to a particular theory, the increase in the EVOH content of a nanocomposite may have induced the nanofiller to agglomerate, i.e., a reverse exfoliation process appeared to be taking place, which may have been thermodynamic or morphological in-origin.

An advantage of the above mentioned method for making a nanocomposite is a nanofiller that cannot be directly exfoliated in a desired polymer can be exfoliated, when the desired polymer is combined with a miscible precursor having the exfoliated nanofiller to form a nanocomposite. Further, a nanocomposite of the above method can have improved barrier properties to fuel components when compared to the untreated desired polymer, which if used for example in a fuel tank, can provide enhanced resistance to fuel permeation leading to less evaporative emissions. Another advantage is that the permeation barrier in a fuel tank incorporating the nanocomposite polymer fuel permeation barrier layer can result in cost savings of the fuel tank. Another advantage is the easier processing behavior that a miscible blend can have compared to the pure components by themselves.

Employing the first polymer to form the precursor enables exfoliation of greater than or equal to about 10 wt % of the nanofiller in the second (desired) polymer (i.e., the nanocomposite has greater than or equal to 10 wt % exfoliated nanofiller), with exfoliation of greater than or equal to about 15 wt % preferred, exfoliation of greater than or equal to about 25 wt % more preferred, exfoliation of greater than or equal to about 50 wt % even more preferred, exfoliation of greater than or equal to about 75 wt % yet more preferred, and exfoliation of greater than or equal to about 90 wt % of the nanofiller in the nanocomposite especially preferred (based upon the total weight of the nanofiller). Basically wherein the nanofiller did not exfoliate directly into the desired polymer, with the employment of the first polymer, the nanofiller can be exfoliated in the second polymer (i.e., in the nanocomposite).

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method for producing a nanocomposite, comprising:
exfoliating a nanofiller in a first polymer to form a precursor; and
combining the precursor with a second polymer to exfoliate the nanofiller in the second polymer, wherein the second polymer is miscible with the first polymer and less than 10 wt % of the nanofiller exfoliates when mixed directly with the second polymer, and wherein greater than or equal to about 15 wt % of the nanofiller exfoliates in the nanocomposite when the precursor and the second polymer are combined.

2. The method of claim 1, wherein the first polymer is selected from the group consisting of: polyamides, polystyrenes, polyetherimides, acrylates, methacrylate oligomers, polymethyl methacrylates, polypropylenes, polyethylene oxides, epoxies, polyimides, polyesters, polycarbonates, acrylonitrile-butadiene-styrene copolymers, and combinations comprising at least one of the foregoing first polymers.

3. The method of claim 1, wherein the first polymer comprises polycaproamide.

4. The method of claim 3, wherein the second polymer comprises ethylene-vinyl alcohol copolymer.

5. The method of claim 4, wherein the second polymer comprises about 25 to about 45 mole percent ethylene.

6. The method of claim 5, further comprising combining about 10 wt % to about 50 wt % of the second polymer with the precursor.

7. The method of claim 1, wherein the nanofiller comprises synthetic phillosilicate.

8. The method of claim 1, comprising greater than or equal to about 25 wt % exfoliated nanofiller, based upon the total weight of the nanofiller.

9. The method of claim 8, comprising greater than or equal to about 50 wt % exfoliated nanofiller, based upon the total weight of the nanofiller.

10. The method of claim 9, comprising greater than or equal to about 90 wt % exfoliated nanofiller, based upon the total weight of the nanofiller.

11. The product of the method of claim 1.

12. The product of claim 11, wherein the article is a barrier layer in a fuel-carrying device.

13. The product of claim 12, wherein the barrier layer is about 0.04 millimeters to about 1 millimeter.

14. The product of claim 12, the fuel tank further comprises an inner layer and an outer layer, wherein the barrier layer is disposed there between.

15. A nanocomposite comprising:
a first polymer having a nanofiller exfoliated in the first polymer; and
a second polymer, wherein the second polymer is miscible with the first polymer and less than 10 wt % of the nanofiller exfoliates when mixed directly with the second polymer, and wherein greater than or equal to about 15 wt % the nanofiller exfoliates in the nanocomposite when the precursor and second polymer are combined.

16. The nanocomposite of claim 15, wherein the first polymer is selected from the group consisting of: polyamides, polystyrenes, polyetherimides, acrylates methacrylate oligomers, polymethyl methacrylates, polypropylenes, polyethylene oxides, epoxies, polyimides, polyesters, polycarbonates, acrylonitrile-butadiene-styrene copolymers, and combination comprising at least one of the foregoing first polymers.

17. The nanocomposite of claim 15, wherein the first polymer comprises polycaproamide.

18. The nanocomposite of claim 17, wherein the second polymer comprises ethylene-vinyl alcohol copolymer.

19. The nanocomposite of claim 18, wherein the second polymer comprises about 25 to about 45 mole percent ethylene.

20. The nanocomposite of claim 18, comprising about 10 wt % to about 60 wt % of the second polymer.

21. The nanocomposite of claim 15, wherein the nanofiller comprises synthetic phillosilicate.

22. The nanocomposite of claim 12, comprising greater than or equal to about 25 wt % exfoliated nanofiller, based upon the total weight of the nanofiller.

23. The nanocomposite of claim 22, comprising greater than or equal to about 50 wt % exfoliated nanofiller, based upon the total weight of the nanofiller.

24. The nanocomposite of claim 23, comprising greater than or equal to about 90 wt % exfoliated nanofiller, based upon the total weight of the nanofiller.

25. A nanocomposite, comprising:
polycaproamide, having a nanofiller exfoliated in the polycaproamide;
an ethylene-vinyl alcohol copolymer; and wherein the ethylene-vinyl alcohol copolymer is miscible with the polycaproamide is present in an amount of about 10 wt % to about 60 wt % based on the total weight of the nanocomposite and less than 10 wt % of the nanofiller exfoliates when mixed directly with the second polymer, and greater than or equal to about 15 wt % the nanofiller exfoliates in the nanocomposite when the precursor and second polymer are combined.

26. A fuel tank for a vehicle comprising:
a tank shell having a wall formed from a plurality of layers, wherein the plurality of layers comprises at least an inner layer and an outer layer; and
a barrier layer disposed between the inner layer and the outer layer, wherein the barrier layer comprises a nanocomposite comprising a polycaproamide having a nanofiller exfoliated in the polycaproamide and an ethylene-vinyl alcohol copolymer, wherein the ethylene-vinyl alcohol copolymer is miscible with the polycaproamide and is present in an amount of about 10 wt % to about 60 wt % based on the total weight of the nanocomposite, wherein less than 10 wt % of the nanofiller exfoliates when mixed directly with the second polymer, and wherein greater than or equal to about 15 wt % the nanofiller exfoliates in the nanocomposite when the polycaproamide and second polymer are combined.
